(19) United States
(12) Patent Application Publication
(10) Pub. No.: US 2025/0239178 A1
(43) Pub. Date: Jul. 24, 2025

(54) POWER SUPPLY SYSTEMS FOR PATIENT SIMULATORS

(71) Applicant: GAUMARD SCIENTIFIC COMPANY, INC., Miami, FL (US)

(72) Inventor: Lazaro MORALES, Miami, FL (US)

(21) Appl. No.: 19/028,985

(22) Filed: Jan. 17, 2025

Related U.S. Application Data
(60) Provisional application No. 63/622,656, filed on Jan. 19, 2024.

(51) Int. Cl. G09B 23/30; G09B 23/34; H02J 7/00

(52) U.S. Cl. CPC G09B 23/303; G09B 23/34; H02J 7/0013

(57) ABSTRACT

Power supply systems for patient simulators and associated devices, systems, and methods are provided. In some instances, a patient simulator comprises: a simulated torso containing at least one of a pump, a compressor, or a control unit; and a simulated extremity configured to be selectively coupled to the simulated torso, the simulated extremity containing a power source assembly configured to provide power to at least one of the pump, the compressor, or the control unit. The simulated extremity may comprise at least one of a simulated leg portion or a simulated arm portion. The power source assembly may be positioned within a housing sized and shaped to simulate a portion of the simulated extremity.

### CROSS-REFERENCE TO RELATED APPLICATIONS

The present application claims priority to and the benefit of U.S. Provisional Patent Application No. 63/622,656, filed Jan. 19, 2024, which is hereby incorporated by reference in its entirety for all applicable purposes.

### INTRODUCTION

The present disclosure relates generally to patient simulators. While it is desirable to train medical personnel in patient care protocols before allowing contact with real patients, textbooks and flash cards lack the important benefits to students that can be attained from hands-on practice. On the other hand, allowing inexperienced students to perform medical procedures on actual patients that would allow for the hands-on practice cannot be considered a viable alternative because of the inherent risk to the patient. Because of these factors patient care education has often been taught using medical instruments to perform patient care activity on a simulator, such as a manikin. Examples of such simulators include those disclosed in U.S. Pat. Nos. 11,756,451, 8,696,362, 8,016,598, 7,976,312, 7,976,313, U.S. patent application Ser. No. 11/952,669 (Publication No. 20090148822), U.S. Pat. Nos. 7,114,954, 6,758,676, 6,503,087, 6,527,5586,443,7356,193,519, and 5,853,292, each herein incorporated by reference in its entirety.

While these simulators have been adequate in many respects, they have not been adequate in all respects. Therefore, what is needed is an interactive education system for use in conducting patient care training sessions that is even more realistic and/or includes additional simulated features.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

This disclosure describes power supply systems for patient simulators. The power supply systems include one or more power sources that may supply electrical power to pump(s), compressor(s), control unit(s), reservoir(s), including one or more valves associated with the pump(s), compressor(s), and/or reservoir(s), other power source(s) and/or power supply systems, and/or various other features/components of the patient simulator. The features/components to which electrical power is supplied by the power source(s) of the power supply system(s) may be contained in a simulated torso, a simulated head, a simulated right arm, a simulated left arm, a simulated right leg, a simulated left leg, or a portion thereof.

In some instances, the power supply system and/or components thereof (e.g., power source(s)) may be positioned within one or more extremities (e.g., the simulated right arm, the simulated left arm, the simulated right leg, the simulated left leg, and/or portions thereof) of the patient simulator. In this regard, an extremity containing the power supply system and/or power source(s) 225 may be detachably coupled to the simulated torso. In some aspects, the extremity containing the power supply system and/or power source(s) may include a quick-connect connector to facilitate simple and/or fast power system changes (e.g., by swapping an extremity with a depleted power source for an extremity with a charged power source). In this regard, the quick-connect connector may physically couple the extremity to the simulated torso and/or another aspect of the patient simulator (e.g., upper and/or lower arm, upper and/or lower leg, etc.). The quick-connect connector may also electrically couple the power source(s) contained in the extremity to one or more components of the patient simulator (e.g., the pump(s), the compressor(s), the control unit(s), the reservoir(s), including one or more valves associated with the pump(s), compressor(s), and/or reservoir(s), other power source(s) and/or power supply systems, and/or various other features/components), including components positioned with other simulated parts/portions of the patient simulator. In some aspects, the quick-connect connector may also pneumatically and/or fluidly couple one or more components contained in the extremity (along with the power source(s) and/or power supply system) to one or more other components of the patient simulator, including components positioned with other simulated parts/portions of the patient simulator.

In some aspects, the power source(s) of the power supply system may include lithium battery technology. In this regard, lithium battery technology reduces weight, volume, and complexity while providing greater power density as compared to traditional battery technologies (e.g., nickel metal hydride and/or nickel-cadmium) used in patient simulators. However, any suitable battery technology may be used in accordance with the present disclosure, including without limitation lithium, lithium-ion, lithium-sulfur, lithium manganese oxide, lithium polymer, lithium titanate, lithium cobalt oxide, lithium iron phosphate, nickel metal hydride, nickel-cadmium, alkaline, supercapacitor, sodium-ion, magnesium, etc.

In some aspects, the invention relates to a patient simulator that includes a simulated torso and a simulated extremity. The simulated torso contains at least one of a pump, a compressor, or a control unit that are used to create realistic physiological responses in the patient simulator. The simulated extremity, which can be a simulated leg portion or a simulated arm portion, contains a power source assembly that provides power to at least one of the pump, the compressor, or the control unit. The power source assembly is located within a housing that is sized and shaped to simulate a portion of the simulated extremity. The power source assembly includes one or more power sources, such as batteries, a controller, and a fan. The housing is covered with a simulated skin layer that has an opening for accessing a charging port coupled to the power sources. The controller can selectively activate the fan to manage the temperature of the power sources. The simulated extremity can be selectively coupled to the simulated torso using a quick-connect connector that provides mechanical and electrical connections. The quick-connect connector can also provide a pneumatic connection and/or a fluid connection for simulating blood flow or airway pressure. The simulated extremity can be replaced with another simulated extremity that also contains a power source assembly for executing different simulated medical scenarios using the patient simulator. The invention also relates to a method of using the patient simulator and the simulated extremity, as well as the simulated extremity itself.

For example, in some instances a patient simulator, comprises: a simulated torso containing at least one of a pump, a compressor, or a control unit; and a simulated extremity configured to be selectively coupled to the simulated torso, the simulated extremity containing a power source assembly configured to provide power to at least one of the pump, the compressor, or the control unit. The simulated extremity may comprise at least one of a simulated leg portion or a simulated arm portion. The power source assembly may be positioned within a housing sized and shaped to simulate a portion of the simulated extremity. The power source assembly may include one or more power sources, a controller, and a fan. The housing may be covered with a simulated skin layer. A charging port coupled to the one or more power sources may be accessible through an opening in the simulated skin layer. The controller may be configured to selectively activate the fan to manage a thermal property of the one or more power sources. The housing may be coupled to a quick-connect connector. The quick-connect connector may be configured to selectively couple the simulated extremity to another portion of the patient simulator. The quick-connect connector may be configured to provide mechanical, electrical, pneumatic, and/or fluid connections. The patient simulator may further comprise an additional simulated extremity configured to be selectively coupled to the simulated torso. The additional simulated extremity may contain a power source assembly configured to provide power to at least one of the pump, the compressor, or the control unit. The additional simulated extremity may be configured to replace the simulated extremity.

In some instances, a method comprises: coupling a simulated extremity to a simulated torso of a patient simulator, wherein the simulated torso contains at least one of a pump, a compressor, or a control unit and the simulated extremity contains a power source assembly; and executing a simulated medical scenario using the patient simulator, wherein executing the simulated medical scenario includes using the power source assembly to power at least one of the pump, the compressor, or the control unit. Coupling the simulated extremity to the simulated torso may include coupling at least one of a simulated leg portion or a simulated arm portion to the simulated torso. The power source assembly may include one or more power sources, a controller, and a fan positioned within a housing sized and shaped to simulate a portion of the simulated extremity. The method may further include charging the one or more power sources using a charging port accessible through an opening in a simulated skin layer covering the housing. Coupling the simulated extremity to the simulated torso may comprise coupling the simulated extremity using a quick-connect connector providing mechanical, electrical, pneumatic, and/or fluid connections. The method may further comprise: uncoupling the simulated extremity from the simulated torso; coupling an additional simulated extremity to the simulated torso, the additional simulated extremity containing a power source assembly; and executing an additional simulated medical scenario using the patient simulator, wherein executing the additional simulated medical scenario includes using the power source assembly of the additional simulated extremity to power at least one of the pump, the compressor, or the control unit.

In some instances, a simulated extremity for use with a patient simulator, comprises: a simulated extremity configured to be selectively coupled to a simulated torso of the patient simulator, the simulated extremity containing a power source assembly configured to provide power to at least one of a pump, a compressor, or a control unit of the patient simulator, wherein the power source assembly is positioned within a housing sized and shaped to simulate a portion of the simulated extremity. The simulated extremity may comprise at least one of a simulated leg portion or a simulated arm portion. The power source assembly may include one or more power sources, a controller, and a fan. The housing may be covered with a simulated skin layer. A charging port coupled to the one or more power sources may be accessible through an opening in the simulated skin layer.

The modularity of the power supplies for patient simulators of the present applications provides numerous advantages. The power supply components can be positioned within the extremities of the simulator, such as the arms and legs, which can be detachably coupled to the torso. This modular design allows for quick and easy replacement of power sources. For instance, an extremity with a depleted power source can be swiftly swapped out for one with a charged power source using a quick-connect connector. The quick-connect connector not only physically attaches the extremity to the torso but can also provide electrical, pneumatic, and/or fluid connections to other components of the simulator, enhancing the ease of maintenance and reducing downtime.

Additionally, the use of advanced battery technologies, particularly lithium-based batteries, offers further benefits. Lithium batteries are known for their high power density. This reduction in weight and volume simplifies the design and handling of the power supply for the patient simulator, making the patient simulator as a whole more efficient and user-friendly. Moreover, the system is versatile in terms of battery compatibility, supporting a wide range of battery technologies, which provides flexibility in choosing the most suitable power source for the needs of specific types of patient simulators and/or particular medical simulation scenarios. Overall, the power supply systems of the present disclosure enhance the functionality, maintainability, and efficiency of patient simulators, making them more effective tools for medical training and simulation.

Other aspects, features, and embodiments of the present invention will become apparent to those of ordinary skill in the art, upon reviewing the following description of specific, exemplary instances of the present invention in conjunction with the accompanying figures. While features of the present invention may be discussed relative to certain examples and figures below, all aspects of the present invention can include one or more of the advantageous features discussed herein. In other words, while one or more arrangements may be discussed as having certain advantageous features, one or more of such features may also be used in accordance with the various aspects and examples of the invention discussed herein. In similar fashion, while exemplary aspects may be discussed below in the context of a device, a system, or a method, it should be understood that such exemplary aspects can be implemented in various devices, systems, and methods.

### BRIEF DESCRIPTION OF THE DRAWINGS

Other features and advantages of the present disclosure will become apparent in the following detailed description of illustrative embodiments with reference to the accompanying of drawings, of which:

FIG. 1 is a perspective view of a patient simulator including a simulated torso, a simulated head, a simulated neck, a simulated right arm, a simulated left arm, a simulated right leg, and a simulated left leg, including at least one extremity with a power source assembly according to one or more aspects of the present disclosure.

FIG. 2 is a perspective side view of a power source assembly for use in an extremity of a patient simulator according to one or more aspects of the present disclosure.

FIG. 3 is a perspective view of a portion of the power source assembly of FIG. 2, according to one or more aspects of the present disclosure.

FIG. 4 is a perspective top view of the power source assembly of FIGS. 2-3, according to one or more aspects of the present disclosure.

FIG. 5 is top view of a female connector portion of the power source assembly of FIGS. 2-4, according to one or more aspects of the present disclosure.

FIG. 6 is a perspective view of male connector portion for mating with the female connector portion of FIG. 5, according to one or more aspects of the present disclosure.

FIG. 7 is a perspective side view of a housing of the power source assembly of FIGS. 2-5, according to one or more aspects of the present disclosure.

FIG. 8 is a perspective side view of the housing of FIG. 7 with one or more covers removed, according to one or more aspects of the present disclosure.

FIG. 9 is an alternative perspective view of the housing of FIG. 7, according to one of more aspects of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications in the described devices, instruments, methods, and any further application of the principles of the disclosure as described herein are contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately. For simplicity, in some instances the same reference numbers are used throughout the drawings to refer to the same or like parts.

One of the aims of healthcare simulation is to establish a teaching environment that closely mimics key clinical cases in a reproducible manner. The introduction of high fidelity tetherless simulators, such as those available from Gaumard Scientific Company, Inc., over the past few years has proven to be a significant advance in creating realistic teaching environments. The present disclosure is directed to a patient simulator that expands the functionality of the simulators by increasing the realism of the look, feel, and functionality of the simulators that can be used to train medical personnel in a variety of clinical situations. The patient simulator disclosed herein offers a training platform on which medical scenarios can be performed for the development of medical treatment skills and the advancement of patient safety. Accordingly, the user's medical treatment skills can be obtained and/or improved in a simulated environment without endangering a live patient. Moreover, the patient simulator allows for multiple users to simultaneously work with the patient simulator during a particular medical scenario, thereby facilitating team training and assessment in a realistic, team-based environment.

In several aspects, the patient simulator includes features designed to enhance the educational experience. For example, in several aspects, the system includes a processing module to simulate different medical and/or surgical scenarios during operation of the patient simulator. In several aspects, the system includes a camera system that allows visualization of the procedure for real-time video and log capture for debriefing purposes. In several aspects, the patient simulator is provided with a workbook of medical scenarios that are pre-programmed in an interactive software package, thereby providing a platform on which medical scenarios can be performed for the development of medical treatment skills and general patient safety. Thus, the patient simulators disclosed herein provide a system that is readily expandable and updatable without large expense and that enables users to learn comprehensive medical and surgical skills through “hands-on” training, without sacrificing the experience gained by users in using standard surgical instruments in a simulated patient treatment situation.

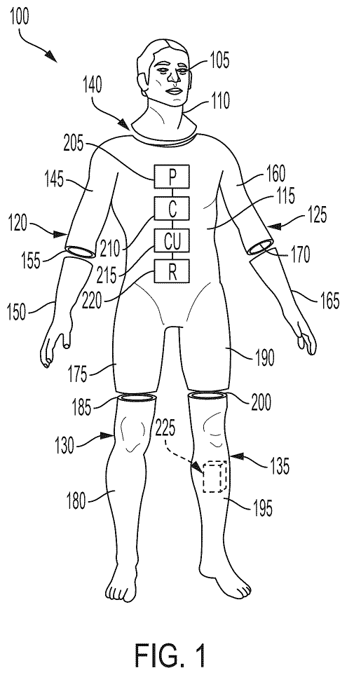

Referring to FIG. 1, in some aspects, a patient simulator is generally referred to by the reference numeral 100 and includes a simulated head 105, a simulated neck 110, a simulated torso 115, a simulated right arm 120 (or “extremity”), a simulated left arm 125 (or “extremity”), a simulated right leg 130 (or “extremity”), and a simulated left leg 135 (or “extremity”). In several embodiments, the patient simulator is, includes, or is part of, a manikin. The simulated head 105 may be coupled to the simulated neck 110. For example, the simulated head 105 may be integrally formed with and/or detachably coupled to the simulated neck 110. The patient simulator 100 may further include a head coupling 140. The simulated neck 110 may be adapted to be detachably coupled to the simulated torso 115 via the head coupling 140. In some aspects, the simulated right arm 120 includes a simulated upper right arm 145 (or “extremity”) and a simulated lower right arm 150 (or “extremity”). The simulated upper right arm 145 may be coupled to the simulated torso 115. For example, the simulated upper right arm 145 may be integrally formed with and/or detachably coupled to the simulated torso 115. The simulated right arm 120 may further include a right arm coupling 155 (or “extremity coupling”). The simulated lower right arm 150 may be detachably coupled to the simulated upper right arm 145 via the right arm coupling 155. Similarly, the simulated left arm 125 may include a simulated upper left arm 160 (or “extremity”) and a simulated lower left arm 165 (or “extremity”). The simulated upper left arm 160 may be coupled to the simulated torso 115. For example, the simulated upper left arm 160 may be integrally formed with and/or detachably coupled to the simulated torso 115. The simulated left arm 125 may further include a left arm coupling 170 (or “extremity coupling”). The simulated lower left arm 165 may be detachably coupled to the simulated upper left arm 160 via the left arm coupling 170.

The simulated right leg 130 may include a simulated upper right leg 175 (or “extremity”) and a simulated lower right leg 180 (or “extremity”). The simulated upper right leg 175 may be coupled to the simulated torso 115. For example, the simulated upper right leg 175 may be integrally formed with and/or detachably coupled to the simulated torso 115. The simulated right leg 130 may further include a right leg coupling 185 (or “extremity coupling”). The simulated lower right leg 180 may be detachably coupled to the simulated upper right leg 175 via the right leg coupling 185. Similarly, the simulated left leg 135 may include a simulated upper left leg 190 (or “extremity”) and a simulated lower left leg 195 (or “extremity”). The simulated upper left leg 190 may be coupled to the simulated torso 115. For example, the simulated upper left leg 190 may be integrally formed with and/or detachably coupled to the simulated torso 115. The simulated left leg 135 may further include a left leg coupling 200 (or “extremity coupling”). The simulated lower left leg 195 may be detachably coupled to the simulated upper left leg 190 via the left leg coupling 200.

In some instances, the simulated torso 115 may be divided into a simulated upper torso and a simulated lower torso. In such instances, the simulated upper right arm 145 and the simulated upper left arm 160 may be coupled to the simulated upper torso. For example, the simulated upper right arm 145 and the simulated upper left arm 160 may be integrally formed with and/or detachably coupled to the simulated upper torso. The simulated upper right leg 175 and the simulated upper left leg 190 may be coupled to the simulated lower torso. For example, the simulated upper right leg 175 and the simulated upper left leg 190 may be integrally formed with and/or detachably coupled to the simulated lower torso. The simulated torso 115 may further includes a torso coupling via which the simulated upper torso may be detachably coupled to the simulated lower torso.

The simulated torso 115 (as well as the simulated head 105, simulated neck 110, simulated right arm 120, simulated left arm 125, a simulated right leg 130, and/or simulated left leg 135) may contain one or more pump(s) 205, compressor(s) 210, control unit(s) 215, reservoir(s) 220, power source(s) 225, and/or other components. The pump(s) 205 may be adapted to supply hydraulic pressure to various features/components of the patient simulator 100. The features/components to which hydraulic pressure is supplied by the pump(s) 205 may be contained in the simulated torso 115, the simulated head 105, the simulated right arm 120, the simulated left arm 125, the simulated right leg 130, and/or the simulated left leg 135. In some instances, the pump(s) 205 may supply hydraulic pressure to one or more of the reservoir(s) 220. For example, the pump(s) 205 may cause fluid to be transferred into and/or out of one or more of the reservoir(s) 220. In this regard, the reservoir(s) 220 may contain fluid and/or gas.

The compressor(s) 210 may be adapted to supply pneumatic pressure to various features/components of the patient simulator 100. The features/components to which pneumatic pressure is supplied by the compressor(s) 210 may be contained in the simulated torso 115, the simulated head 105, the simulated right arm 120, the simulated left arm 125, the simulated right leg 130, and/or the simulated left leg 135. In some instances, the compressor(s) 210 may include a scroll compressor. In some instances, the compressor(s) 210 may supply pneumatic pressure to one or more of the reservoir(s) 220. In this regard, the reservoir(s) 220 may contain fluid and/or gas.

The control unit(s) 215 may be adapted to control the pump(s) 205, the compressor(s) 210, the reservoir(s) 220, including one or more valves associated with the pump(s), compressor(s), and/or reservoir(s), and/or various other features/components of the patient simulator 100. The features/components controlled by the control unit(s) 215 may be contained in the simulated torso 115, the simulated head 105, the simulated right arm 120, the simulated left arm 125, the simulated right leg 130, and/or the simulated left leg 135. In some instances, each of the control unit(s) 215 may be associated with one or more functions and/or features of the patient simulator 100.

The reservoir(s) 220 may contain fluid and/or gas for use in simulating one or more scenarios, functions, and/or features. For example, the reservoir(s) 220 may contain simulated bodily fluids (e.g., blood, urine, saliva, tears, etc.) and/or simulated bodily gasses (e.g., air, O₂, CO2, etc.). The reservoir(s) 220 may include a single compartment or multiple compartments. The reservoir(s) 220 may be associated with one or more valves to control the flow of fluid and/or gas into and/or out of the reservoir(s) 220.

The power source(s) 225 may supply electrical power to the pump(s) 205, the compressor(s) 210, the control unit(s) 215, the reservoir(s) 220, including one or more valves associated with the pump(s), compressor(s), and/or reservoir(s), and various other features/components of the patient simulator 100. The features/components to which electrical power is supplied by the power source(s) 225 may be contained in the simulated torso 115, the simulated head 105, the simulated right arm 120, the simulated left arm 125, the simulated right leg 130, and/or the simulated left leg 135. In some aspects, the power source(s) 225 includes lithium battery technology that reduces weight, volume, and complexity while providing greater power density. However, any suitable battery technology may be used in accordance with the present disclosure, including without limitation lithium, lithium-ion, lithium-sulfur, lithium manganese oxide, lithium polymer, lithium titanate, lithium cobalt oxide, lithium iron phosphate, nickel metal hydride, nickel-cadmium, alkaline, supercapacitor, sodium-ion, magnesium, etc.

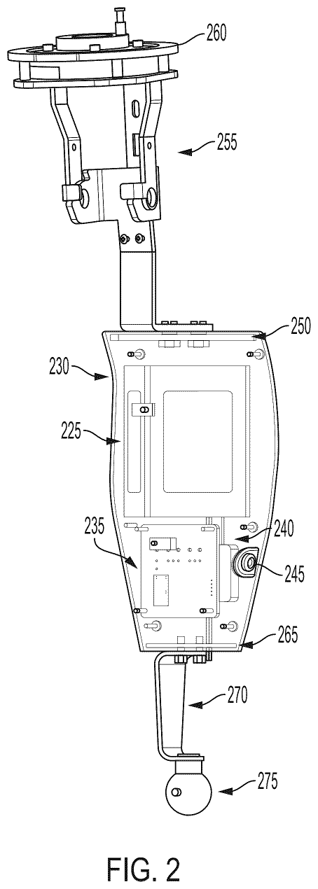

In some instances, the power source(s) 225 may be positioned within one or more extremities (e.g., the simulated right arm 120, the simulated left arm 125, the simulated right leg 130, and/or the simulated left leg 135) of the patient simulator 100. In this regard, an extremity containing the power source(s) 225 may be detachably coupled to the simulated torso 115. In some aspects, the extremity containing the power source(s) 225 may include a quick-connect connector to facilitate simple and/or fast power system changes (e.g., by swapping an extremity with a depleted power source for an extremity with a charged power source). In this regard, the quick-connect connector may physically couple the extremity to the simulated torso 115 and/or another aspect of the patient simulator 100 (e.g., upper and/or lower arm, upper and/or lower leg, etc.). The quick-connect connector may also electrically couple the power source(s) 225 contained in the extremity to one or more components of the patient simulator 100 (e.g., the pump(s) 205, the compressor(s) 210, the control unit(s) 215, the reservoir(s) 220, including one or more valves associated with the pump(s), compressor(s), and/or reservoir(s), other power source(s), and various other features/components), including components positioned with other simulated parts/portions of the patient simulator 100. In some aspects, the quick-connect connector may also pneumatically and/or fluidly couple one or more components (e.g., pump(s) 205, compressor(s) 210, reservoir(s) 220, valve(s), and other pneumatic and/or fluid components) contained in the extremity (along with the power source(s) 225) to one or more other components of the patient simulator 100 (e.g., the pump(s) 205, the compressor(s) 210, the reservoir(s) 220, valve(s), and various other features/components). Additional details regarding some aspects of extremities containing the power source(s) 225 will be discussed in the context of FIGS. 2-9.

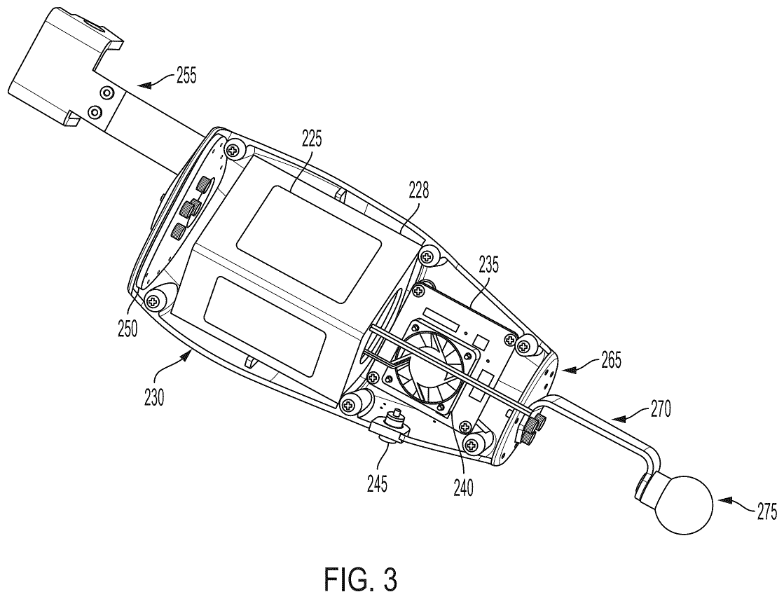

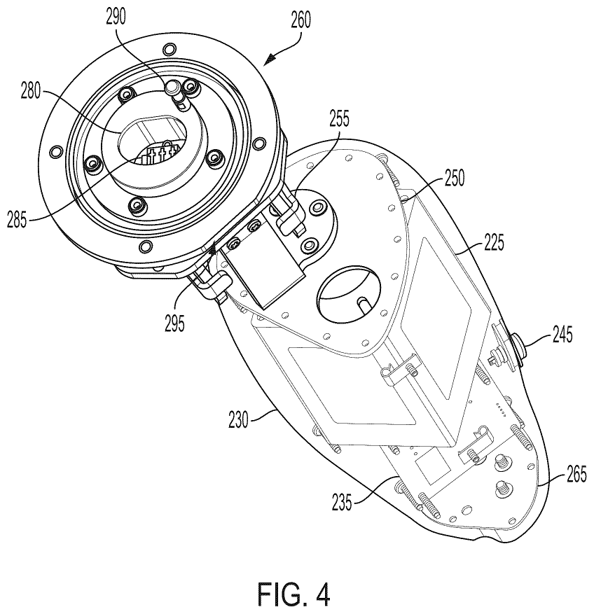

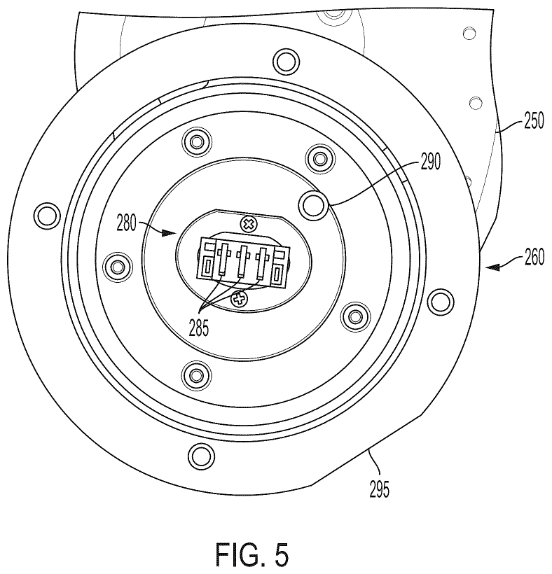

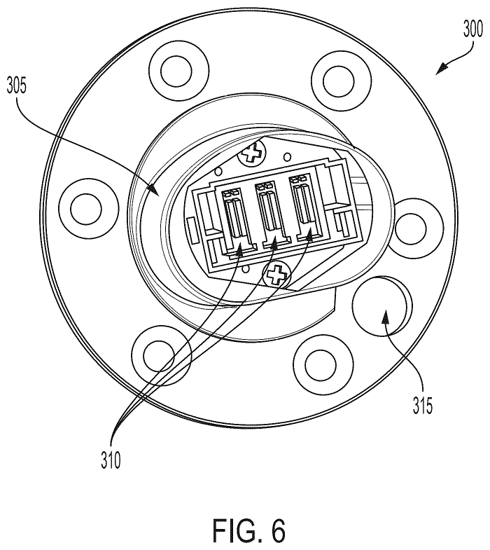

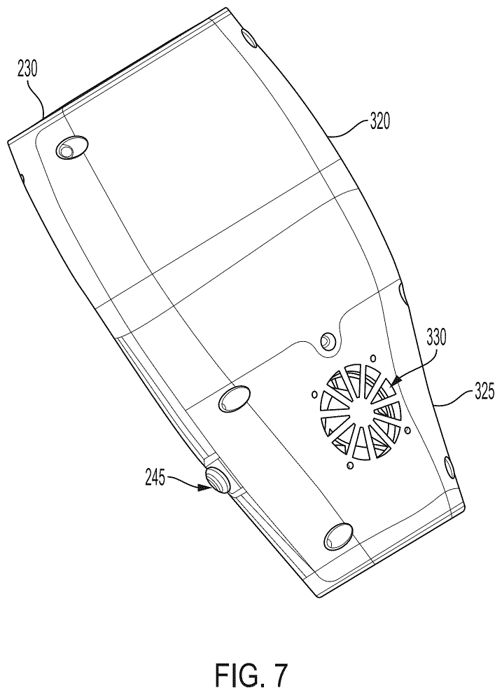

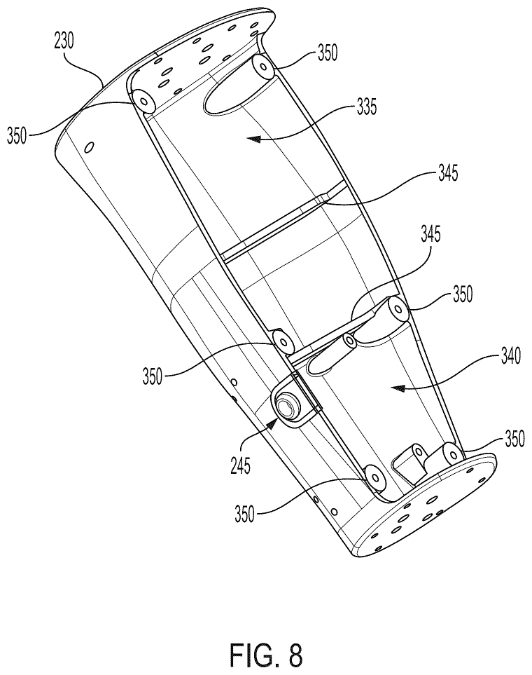

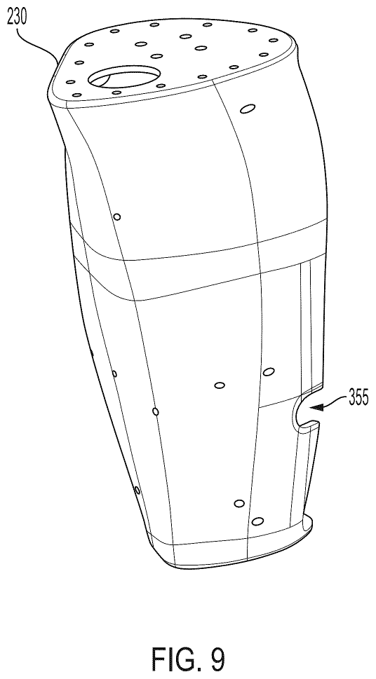

Referring to FIGS. 2-9 and continuing reference to FIG. 1, the patient simulator 100 may include an extremity with a power source assembly or power supply system that includes one or more power source(s) 225. For example, FIG. 2 is a perspective side view of a power source assembly for use in an extremity of a patient simulator according to one or more aspects of the present disclosure. FIG. 3 is a perspective view of a portion of the power source assembly of FIG. 2, according to one or more aspects of the present disclosure. FIG. 4 is a perspective top view of the power source assembly of FIGS. 2-3, according to one or more aspects of the present disclosure. FIG. 5 is top view of a female connector portion of the power source assembly of FIGS. 2-4, according to one or more aspects of the present disclosure. FIG. 6 is a perspective view of male connector portion for mating with the female connector portion of FIG. 5, according to one or more aspects of the present disclosure. FIG. 7 is a perspective side view of a housing of the power source assembly of FIGS. 2-5, according to one or more aspects of the present disclosure. FIG. 8 is a perspective side view of the housing of FIG. 7 with one or more covers removed, according to one or more aspects of the present disclosure. FIG. 9 is an alternative perspective view of the housing of FIG. 7, according to one of more aspects of the present disclosure.

As best seen in FIGS. 2-4, the power source assembly includes one or more power source(s) 225, a housing 230, a controller 235, a fan 240, a charging port 245, an upper mounting plate 250, an upper support structure 255, a quick-connect connector 260, a lower mounting plate 265, a lower support structure 270, and a connection joint 275.

In some instances, the power source(s) 225 may include any suitable type of rechargeable battery. The power source(s) 225 may include lithium battery technology. However, any suitable battery technology may be used in accordance with the present disclosure, including without limitation lithium, lithium-ion, lithium-sulfur, lithium manganese oxide, lithium polymer, lithium titanate, lithium cobalt oxide, lithium iron phosphate, nickel metal hydride, nickel-cadmium, alkaline, supercapacitor, sodium-ion, magnesium, etc. The power source(s) 225 may have an operating voltage (e.g., 5.0-25.0 v, including ˜6, ˜12, ˜14.4, ˜24, or other voltage) and/or amp-hours capacity (e.g, 5-100 Ah, including ˜10, ˜15, ˜17.25, ˜20, ˜40, or other amp-hours capacity) suitable for use by one or more components of the patient simulator. The power source(s) 225 may be partially and/or completely wrapped in a protective sleeve or cover. For example, as shown in FIG. 3, a protective sleeve 228 made of silicone, plastic, or other suitable material may wrap or cover the boundaries of the power source(s) 225 to protect the power source(s) 225 from damage during use and/or transportation of the patient simulator 100 and/or the extremity containing the power source(s) 225.

As shown in FIGS. 2-4 and 7-9, the housing 230 contains the power source(s) 225, the controller 235, the fan 240, and the charging port 245. The housing 230 may be formed of a lightweight plastic or other suitable material. As shown in FIGS. 7-9, the housing 230 may include an upper cover 320 and a lower cover 325. The lower cover 325 may include one or more openings 330 that allows exhaust of heat by the fan 240 from the housing 230, allowing internal thermal control by the power source assembly. As shown in FIG. 8, the housing may include an upper recess 335 sized and shaped for receiving and/or holding the power source(s) and a lower recess 340 sized and shaped for receiving and/or holding the controller 235 and the fan 240. In this regard, the housing 230 may include support structures 345 sized and/or shaped for receiving and/or holding particular components of the power source assembly. The housing 230 also includes mounting and/or engagement structures 350 to facilitate coupling the upper cover 320 and the lower cover 325 to the housing body. In some aspects, the mounting and/or engagement structures 350 may be configured for engagement with a screw (self-tapping or otherwise), bolt, or other engagement mechanism for detachably or permanently coupling the upper cover 320 and/or the lower cover 325 to the housing body. The housing 230 also includes a recess 355 sized and shaped for receiving and/or mounting the charging port 245. In this regard, the charging port 245 allows the power source(s) 225 to be charged by plugging a power cord (e.g., connected to a wall outlet, USB outlet, or other suitable source of power) into the charging port 245. In some aspects, the controller 235 may control one or more aspects of charging, cooling, and/or discharging the power source(s) 225 in conjunction with the fan 240 and/or the charging port 245.

For example, in some aspects the controller 235 can selectively activate the fan 240 to manage the temperature of the power source(s) 225. In some instances, the controller 235 may continuously and/or periodically monitor the temperature of the power source(s) 225, providing real-time temperature data to the controller 235. Based on this temperature data, the controller 235 makes decisions about when to activate (and/or deactivate) the fan 240. For example, if the temperature of the power source(s) 225 exceeds a predefined threshold, the controller 235 will turn on the fan 240 to cool them down. When the controller 235 determines that cooling is necessary, the controller 235 sends a signal to the fan 240 to start operating, creating airflow that helps dissipate the heat generated by the power source(s) 225. By selectively activating the fan 240, the controller 235 ensures that the power source(s) 225 remain within a safe and efficient operating temperature range, preventing overheating, which can lead to reduced performance, potential damage, and/or failure of the power source(s) 225 and/or components of the patient simulator 100. This selective activation also contributes to energy efficiency, as the fan 240 only runs when needed, reducing unnecessary power consumption and wear on the fan 240 itself.

In some instances, the housing 230 is sized and shaped to simulate a portion of one or more extremities (e.g., the simulated right arm 120, the simulated left arm 125, the simulated right leg 130, and/or the simulated left leg 135) of the patient simulator 100. For example, the housing 230 illustrated in FIGS. 7-9 is sized and shaped to simulate a lower leg portion (e.g., calf area) of a simulated leg. The housing 230 may be covered with a simulated skin layer. The charging port 245 may be accessible through an opening in the simulated skin layer. In this manner, the housing 230 and associated power source assembly may be seamlessly integrated into the patient simulator 100 within the associated extremity. In other instances, the housing 230 may be sized and shaped to simulate other portions of extremities, including but not limited to an upper leg portion, a foot portion, a knee portion, an upper arm portion, a lower arm portion, an elbow portion, and/or combinations thereof.

As best seen in FIGS. 4-5, the quick-connect connector 260 includes a female connector 280 with electrical connections 285. The quick-connect connector 260 also includes a mechanical alignment and/or engagement structure 290 and/or a mechanical alignment and/or engagement structure 295 to facilitate connection of the extremity containing the power source assembly to another part of the patient simulator 100. The alignment and/or engagement structure 290 may be configured to interface with a corresponding quick-connect connector 300 (see, e.g., FIG. 6) of the opposing part of the patient simulator 100. For example, as shown in FIG. 6, the quick-connect connector 300 may include a male connector 305 with electrical connections 310 that are configured to engagement with the female connector 280 and electrical connections 285 of the quick-connect connector 260. Further, the quick-connect connector 300 includes an opening 315 that is configured to receive the alignment and/or engagement structure 290 of the quick-connect connector 260. In some aspects, the quick-connect connector 260 and/or the quick-connect connector 300 may include one or more features of the connectors described and disclosed in U.S. Pat. No. 11,756,451, which is hereby incorporated by reference in its entirety, including variations and modifications thereof for particular implementations as would be understood by a person of ordinary skill in the art.

The present application further includes the following aspects:

1. A patient simulator, comprising:
a simulated torso containing at least one of a pump, a compressor, or a control unit; and
a simulated extremity configured to be selectively coupled to the simulated torso, the simulated extremity containing a power source assembly configured to provide power to at least one of the pump, the compressor, or the control unit.
   2. The patient simulator of aspect 1, wherein the simulated extremity comprises at least one of a simulated leg portion or a simulated arm portion.
   3. The patient simulator of any of aspects 1-2, wherein the power source assembly is positioned within a housing sized and shaped to simulate a portion of the simulated extremity.
   4. The patient simulator of aspect 3, wherein the power source assembly includes one or more power sources, a controller, and a fan.
   5. The patient simulator of aspect 4, wherein the housing is covered with a simulated skin layer and a charging port coupled to the one or more power sources is accessible through an opening in the simulated skin layer.
   6. The patient simulator of aspect 4 or 5, wherein the controller is configured to selectively activate the fan to manage a thermal property of the one or more power sources.
   7. The patient simulator of any of aspects 3-6, wherein the housing is coupled to a quick-connect connector, the quick-connect connector configured to selectively couple the simulated extremity to another portion of the patient simulator.
   8. The patient simulator of aspect 7, wherein the quick-connect connector is configured to provide mechanical and electrical connections.
   9. The patient simulator of aspect 8, wherein the quick-connect connector is further configured to provide a pneumatic connection and/or a fluid connection.
   10. The patient simulator of any of aspects 1-9, further comprising an additional simulated extremity configured to be selectively coupled to the simulated torso, the additional simulated extremity containing a power source assembly configured to provide power to at least one of the pump, the compressor, or the control unit, wherein the additional simulated extremity is configured to replace the simulated extremity.
   11. A method, comprising:
coupling a simulated extremity to a simulated torso of a patient simulator, wherein the simulated torso contains at least one of a pump, a compressor, or a control unit and the simulated extremity contains a power source assembly; and
executing a simulated medical scenario using the patient simulator, wherein executing the simulated medical scenario includes using the power source assembly to power at least one of the pump, the compressor, or the control unit.
   12. The method of aspect 11, wherein the coupling the simulated extremity to the simulated torso comprises coupling at least one of a simulated leg portion or a simulated arm portion to the simulated torso.
   13. The method of any of aspects 11-12, wherein the power source assembly includes one or more power sources, a controller, and a fan positioned within a housing sized and shaped to simulate a portion of the simulated extremity.
   14. The method of claim 13, further comprising:
charging the one or more power sources using a charging port accessible through an opening in a simulated skin layer covering the housing.
   15. The method of any of aspects 11-14, wherein the coupling the simulated extremity to the simulated torso comprises coupling the simulated extremity using a quick-connect connector providing mechanical and electrical connections.
   16. The method of aspect 15, wherein the coupling the simulated extremity to the simulated torso using the quick-connect connector further comprises using the quick-connect connector to provide a pneumatic connection and/or a fluid connection.
   17. The method of any of aspects 11-16, further comprising:
uncoupling the simulated extremity from the simulated torso;
coupling an additional simulated extremity to the simulated torso, the additional simulated extremity containing a power source assembly; and
executing an additional simulated medical scenario using the patient simulator, wherein executing the additional simulated medical scenario includes using the power source assembly of the additional simulated extremity to power at least one of the pump, the compressor, or the control unit.
   18. A simulated extremity for use with a patient simulator, comprising:
a simulated extremity configured to be selectively coupled to a simulated torso of the patient simulator, the simulated extremity containing a power source assembly configured to provide power to at least one of a pump, a compressor, or a control unit of the patient simulator, wherein the power source assembly is positioned within a housing sized and shaped to simulate a portion of the simulated extremity.
   19. The simulated extremity of aspect 18, wherein the simulated extremity comprises at least one of a simulated leg portion or a simulated arm portion.
   20. The simulated extremity of any of aspects 18-19, wherein:
the power source assembly includes one or more power sources, a controller, and a fan;
the housing is covered with a simulated skin layer; and
a charging port coupled to the one or more power sources is accessible through an opening in the simulated skin layer.

Although illustrative embodiments have been shown and described, a wide range of modification, change, and substitution is contemplated in the foregoing disclosure and in some instances, some features of the present disclosure may be employed without a corresponding use of the other features. It is understood that such variations may be made in the foregoing without departing from the scope of the embodiment. Accordingly, it is appropriate that the appended claims be construed broadly and in a manner consistent with the scope of the present disclosure.

1. A patient simulator, comprising:
a simulated torso containing at least one of a pump, a compressor, or a control unit; and
a simulated extremity configured to be selectively coupled to the simulated torso, the simulated extremity containing a power source assembly configured to provide power to at least one of the pump, the compressor, or the control unit.

2. The patient simulator of claim 1, wherein the simulated extremity comprises at least one of a simulated leg portion or a simulated arm portion.

3. The patient simulator of claim 1, wherein the power source assembly is positioned within a housing sized and shaped to simulate a portion of the simulated extremity.

4. The patient simulator of claim 3, wherein the power source assembly includes one or more power sources, a controller, and a fan.

5. The patient simulator of claim 4, wherein the housing is covered with a simulated skin layer and a charging port coupled to the one or more power sources is accessible through an opening in the simulated skin layer.

6. The patient simulator of claim 4, wherein the controller is configured to selectively activate the fan to manage a thermal property of the one or more power sources.

7. The patient simulator of claim 3, wherein the housing is coupled to a quick-connect connector, the quick-connect connector configured to selectively couple the simulated extremity to another portion of the patient simulator.

8. The patient simulator of claim 7, wherein the quick-connect connector is configured to provide mechanical and electrical connections.

9. The patient simulator of claim 8, wherein the quick-connect connector is further configured to provide a pneumatic connection and/or a fluid connection.

10. The patient simulator of claim 1, further comprising an additional simulated extremity configured to be selectively coupled to the simulated torso, the additional simulated extremity containing a power source assembly configured to provide power to at least one of the pump, the compressor, or the control unit, wherein the additional simulated extremity is configured to replace the simulated extremity.

11. A method, comprising:
coupling a simulated extremity to a simulated torso of a patient simulator, wherein the simulated torso contains at least one of a pump, a compressor, or a control unit and the simulated extremity contains a power source assembly; and
executing a simulated medical scenario using the patient simulator, wherein executing the simulated medical scenario includes using the power source assembly to power at least one of the pump, the compressor, or the control unit.

12. The method of claim 11, wherein the coupling the simulated extremity to the simulated torso comprises coupling at least one of a simulated leg portion or a simulated arm portion to the simulated torso.

13. The method of claim 11, wherein the power source assembly includes one or more power sources, a controller, and a fan positioned within a housing sized and shaped to simulate a portion of the simulated extremity.

14. The method of claim 13, further comprising:
charging the one or more power sources using a charging port accessible through an opening in a simulated skin layer covering the housing.

15. The method of claim 11, wherein the coupling the simulated extremity to the simulated torso comprises coupling the simulated extremity using a quick-connect connector providing mechanical and electrical connections.

16. The method of claim 15, wherein the coupling the simulated extremity to the simulated torso using the quick-connect connector further comprises using the quick-connect connector to provide a pneumatic connection and/or a fluid connection.

17. The method of claim 11, further comprising:
uncoupling the simulated extremity from the simulated torso;
coupling an additional simulated extremity to the simulated torso, the additional simulated extremity containing a power source assembly; and
executing an additional simulated medical scenario using the patient simulator, wherein executing the additional simulated medical scenario includes using the power source assembly of the additional simulated extremity to power at least one of the pump, the compressor, or the control unit.

18. A simulated extremity for use with a patient simulator, comprising:
a simulated extremity configured to be selectively coupled to a simulated torso of the patient simulator, the simulated extremity containing a power source assembly configured to provide power to at least one of a pump, a compressor, or a control unit of the patient simulator, wherein the power source assembly is positioned within a housing sized and shaped to simulate a portion of the simulated extremity.

19. The simulated extremity of claim 18, wherein the simulated extremity comprises at least one of a simulated leg portion or a simulated arm portion.

20. The simulated extremity of claim 19, wherein:
the power source assembly includes one or more power sources, a controller, and a fan;
the housing is covered with a simulated skin layer; and
a charging port coupled to the one or more power sources is accessible through an opening in the simulated skin layer.
